(19) United States
(12) Patent Application Publication
(10) Pub. No.: US 2016/0073027 A1
(43) Pub. Date: Mar. 10, 2016

(54) IMAGE PROCESSING APPARATUS, CONTROL METHOD THEREFOR, AND STORAGE MEDIUM

(71) Applicant: CANON KABUSHIKI KAISHA, Tokyo (JP)

(72) Inventor: Masaaki Noguchi, Tokyo (JP)

(21) Appl. No.: 14/839,800

(22) Filed: Aug. 28, 2015

(30) Foreign Application Priority Data
Sep. 5, 2014 (JP) 2014-181600

(51) Int. Cl. H04N 5/232

(52) U.S. Cl. CPC H04N 5/23267

(57) ABSTRACT

An image processing apparatus, comprises a setting unit that sets an image stabilization gain of a first image stabilization unit and an image stabilization gain of a second image stabilization unit, the first and second image stabilization units correcting an image blur of a subject image generated by a shake of the apparatus, wherein when the first and second image stabilization units are driven such that the first and second image stabilization units are a different phase with each other by 180 degrees, the setting unit sets the image stabilization gain of the second image stabilization unit such that an amount of a remaining blur in an image is a local minimum.

### BACKGROUND OF THE INVENTION

1. Field of the Invention

The present invention relates to an image processing apparatus with an image stabilization function.

2. Description of the Related Art

In some cases, a shake (image blur) of a subject image is generated by a shaky movement of a hand of a user holding a camera body (by the occurrence of a camera shake) at the time of image capture using an image capturing apparatus, such as a digital camera. An image capturing apparatus with an image stabilization mechanism to correct such an image blur has been proposed.

Conventional examples of correction processing executed by the image stabilization mechanism include optical image stabilization processing and electronic image stabilization processing. In the optical image stabilization processing, vibration applied to a camera body is detected using an angular velocity sensor and the like, and a shake correction lens provided inside an imaging optical system is moved in accordance with the result of detection. In this way, the direction of an optical axis of the imaging optical system is changed, and an image formed on a light receiving surface of an image sensor is moved; accordingly, an image blur is corrected. On the other hand, the electronic image stabilization processing performs pseudo-correction of an image blur by changing an image cutout position in a captured image.

The performance of image stabilization by conventional image stabilization mechanisms is easily influenced by, for example, differences among imaging conditions and differences among the camera shake characteristics of camera operators. The reason why there are differences among the camera shake characteristics of camera operators is because, for example, different camera operators produce a large camera shake in different frequency bandwidths. On the other hand, different imaging conditions include a condition where image capture is performed while riding a vehicle, a condition where image capture is performed while walking, etc. Under such conditions, the amount of image blur is large, and hence an image stabilization mechanism needs to be able to correct a large amount of shake; however, an increase in the amount of image stabilization causes an increase in the size of the image stabilization mechanism.

Japanese Patent Laid-Open No. 2009-258389 discloses an image stabilization apparatus provided with a first movable lens barrel and a second movable lens barrel that respectively hold a first correction member and a second correction member, and that are located respectively at the front and rear of a fixed member.

The image stabilization apparatus disclosed in Japanese Patent Laid-Open No. 2009-258389 can achieve a large correction angle with a small driving stroke by driving the first correction member and the second correction member in opposite directions. However, this gives rise to the problem that optimal correction cannot be performed if the first correction member and the second correction member are not driven in unison.

### SUMMARY OF THE INVENTION

The present invention has been made in view of the above problem, and realizes favorable image stabilization in an apparatus that performs image stabilization by driving two image stabilization members simultaneously.

According to the first aspect of the present invention, there is provided an image processing apparatus, comprising: a setting unit that sets an image stabilization gain of a first image stabilization unit and an image stabilization gain of a second image stabilization unit, the first and second image stabilization units correcting an image blur of a subject image generated by a shake of the apparatus, wherein when the first and second image stabilization units are driven such that the first and second image stabilization units are a different phase with each other by 180 degrees, the setting unit sets the image stabilization gain of the second image stabilization unit such that an amount of a remaining blur in an image is a local minimum.

According to the second aspect of the present invention, there is provided a method for controlling an image processing apparatus that drives a first image stabilization unit and a second image stabilization unit for correcting an image blur of a subject image generated by a shake of the apparatus, the method comprising: setting an image stabilization gain of the first image stabilization unit and an image stabilization gain of the second image stabilization unit, wherein when the first and second image stabilization units are driven such that the first and second image stabilization units are a different phase with each other by 180 degrees, the setting sets the image stabilization gain of the second image stabilization unit such that an amount of a remaining blur in an image is a local minimum.

Further features of the present invention will become apparent from the following description of exemplary embodiments with reference to the attached drawings.

### BRIEF DESCRIPTION OF THE DRAWINGS

FIG. 1 shows a configuration of an image capturing apparatus according to a first embodiment of the present invention.

FIG. 2 shows a configuration of an image stabilization apparatus according to the first embodiment.

FIG. 3 is an exploded perspective view showing a configuration of a first shake correction lens driving unit.

FIG. 4 shows a positional relationship between first and second shake correction lens driving units.

FIG. 5 is a block diagram showing a configuration of the shake correction lens driving units according to the first embodiment.

FIG. 6 shows a configuration of a first position detection unit.

FIGS. 7A and 7B illustrate Hall adjustment.

FIG. 8 shows error in adjustment of the amounts of driving of the first and second shake correction lenses.

FIG. 9 illustrates Hall adjustment according to the first embodiment.

FIG. 10 is a block diagram showing a configuration of the shake correction lens driving units according to a second embodiment.

FIG. 11 is a block diagram showing a configuration of the shake correction lens driving units according to a third embodiment.

### DESCRIPTION OF THE EMBODIMENTS

The following describes embodiments of the present invention with reference to the attached drawings.

### First Embodiment

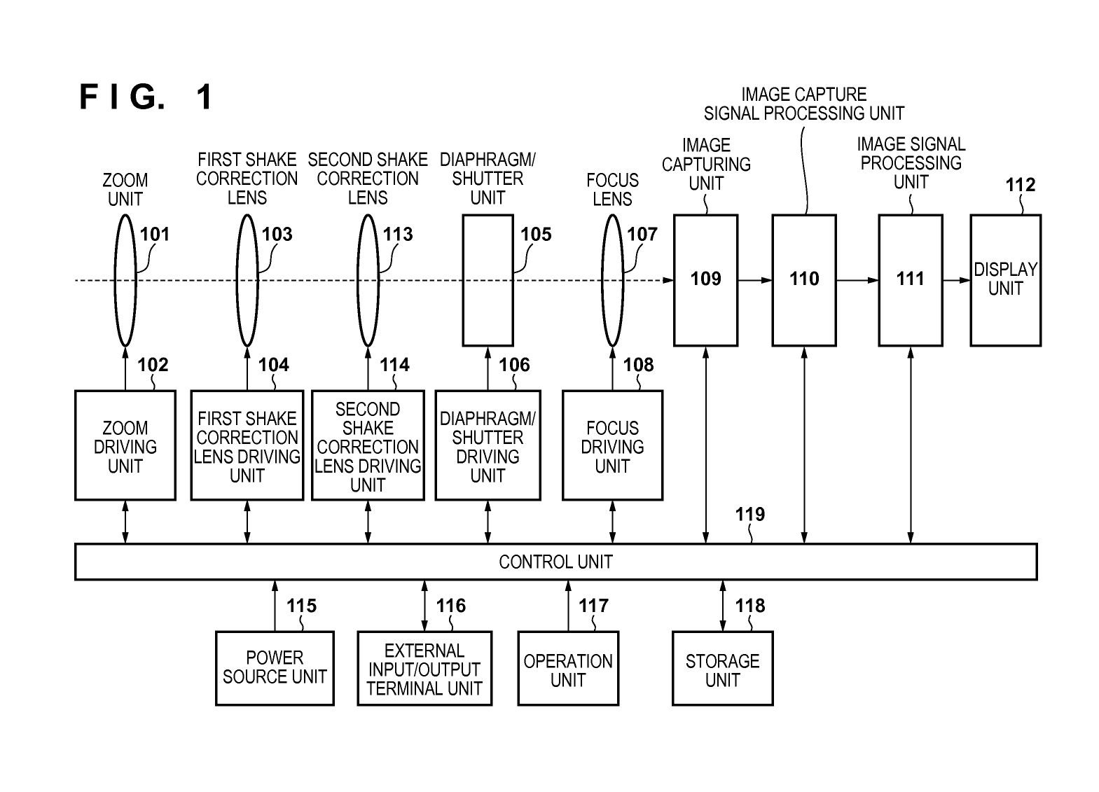

FIG. 1 shows a configuration of an image capturing apparatus according to a first embodiment of the present invention. The image capturing apparatus shown in FIG. 1 is a digital still camera. It should be noted that the image capturing apparatus according to the present embodiment may have a moving image capture function.

The image capturing apparatus shown in FIG. 1 includes a zoom unit 101 to a control unit 119. The zoom unit 101 is a part of a variable-magnification imaging lens that constitutes an imaging optical system. The zoom unit 101 includes a zoom lens that changes the magnification of the imaging lens. A zoom driving unit 102 controls driving of the zoom unit 101 under control by the control unit 119. A first shake correction lens 103 is a correction member that corrects an image blur. The first shake correction lens 103 is configured to be movable in a direction perpendicular to an optical axis of the imaging lens. A first shake correction lens driving unit 104 controls driving of the first shake correction lens 103. A configuration of a second shake correction lens 113 has the same configuration of the first shake correction lens 103. A second shake correction lens driving unit 114 controls driving of the second shake correction lens 113.

A diaphragm/shutter unit 105 is a mechanical shutter with a diaphragm function. A diaphragm/shutter driving unit 106 drives the diaphragm/shutter unit 105 under control by the control unit 119. A focus lens 107 is a part of the imaging lens, and is configured such that the position thereof can be changed along the optical axis of the imaging lens. A focus driving unit 108 drives the focus lens 107 under control by the control unit 119.

An image capturing unit 109 converts a subject image formed by the imaging lens into a pixel-by-pixel electrical signal using an image sensor, such as a CCD image sensor and a CMOS image sensor. CCD is an abbreviation of a charge coupled device. CMOS is an abbreviation of a complementary metal-oxide-semiconductor. An image capture signal processing unit 110 converts the electrical signal output from the image capturing unit 109 into an image signal by applying A/D conversion, correlated double sampling, gamma correction, white balance correction, color interpolation processing, and the like to the electrical signal. An image signal processing unit 111 processes the image signal output from the image capture signal processing unit 110 in accordance with an intended use. Specifically, the image signal processing unit 111 generates an image for display purposes, and performs encoding and generates a file of data for recording purposes.

A display unit 112 displays an image, as necessary, based on an image signal output from the image signal processing unit 111 for display purposes. A power source unit 115 supplies a power source to the entire image capturing apparatus in accordance with an intended use. An external input/output terminal unit 116 handles input and output of a communication signal and an image signal between itself and an external apparatus. An operation unit 117 has buttons, switches, and the like via which a user issues instructions to the image capturing apparatus. A storage unit 118 stores various types of data, such as image information. The control unit 119 includes, for example, a CPU, a ROM, and a RAM, and controls various constituents of the image capturing apparatus by deploying control programs stored in the ROM to the RAM and causing the CPU to execute the deployed control programs, thereby realizing operations of the image capturing apparatus, including a variety of operations described below. CPU is an abbreviation of a central processing unit. ROM is an abbreviation of a read-only memory. RAM is an abbreviation of a random-access memory.

The operation unit 117 has a release button that is configured such that a first switch (SW1) and a second switch (SW2) are turned on in sequence in accordance with the amount of depression. A release switch SW1 is turned on when the release button is pressed halfway down, whereas a release switch SW2 is turned on when the release button is pressed all the way down. Once the release switch SW1 has been turned on, the control unit 119 calculates an AF evaluation value based on the image signal that is output from the image signal processing unit 111 to the display unit 112 for display purposes. The control unit 119 then performs automatic focus adjustment by controlling the focus driving unit 108 based on the AF evaluation value.

The control unit 119 also executes AE processing for deciding on an f-number and a shutter speed to achieve an appropriate amount of exposure based on luminance information of the image signal and on a preset program diagram. Once the release switch SW2 has been turned on, the control unit 119 controls various processing units so as to perform image capture with the decided f-number and shutter speed and store image data obtained by the image capturing unit 109 into the storage unit 118.

The operation unit 117 also has a shake correction switch that enables selection of a shake correction mode. Upon selection of the shake correction mode via the shake correction switch, the control unit 119 instructs the first shake correction lens driving unit 104 and the second shake correction lens driving unit 114 to perform a shake correction operation. In response, the first shake correction lens driving unit 104 and the second shake correction lens driving unit 114 perform the shake correction operation until the issuance of an instruction for stopping the shake correction. The operation unit 117 also has an image capture mode selection switch that enables selection of one of a still image capture mode and a moving image capture mode. Upon selection of either image capture mode through operation on the image capture mode selection switch, the control unit 119 can change operation conditions of the first shake correction lens driving unit 104 and the second shake correction lens driving unit 114. The first shake correction lens driving unit 104 and the second shake correction lens driving unit 114 constitute an image stabilization apparatus according to the present embodiment.

The operation unit 117 also has a playback mode selection switch for selecting a playback mode. Upon selection of the playback mode through operation on the playback mode selection switch, the control unit 119 stops the shake correction operation. The operation unit 117 also has a magnification changing switch for issuing an instruction for changing a zoom magnification. Upon issuance of the instruction for changing the zoom magnification through operation on the magnification changing switch, the zoom driving unit 102 receives the instruction via the control unit 119, and then moves the zoom unit 101 to a zoom position indicated by the instruction by driving the zoom unit 101.

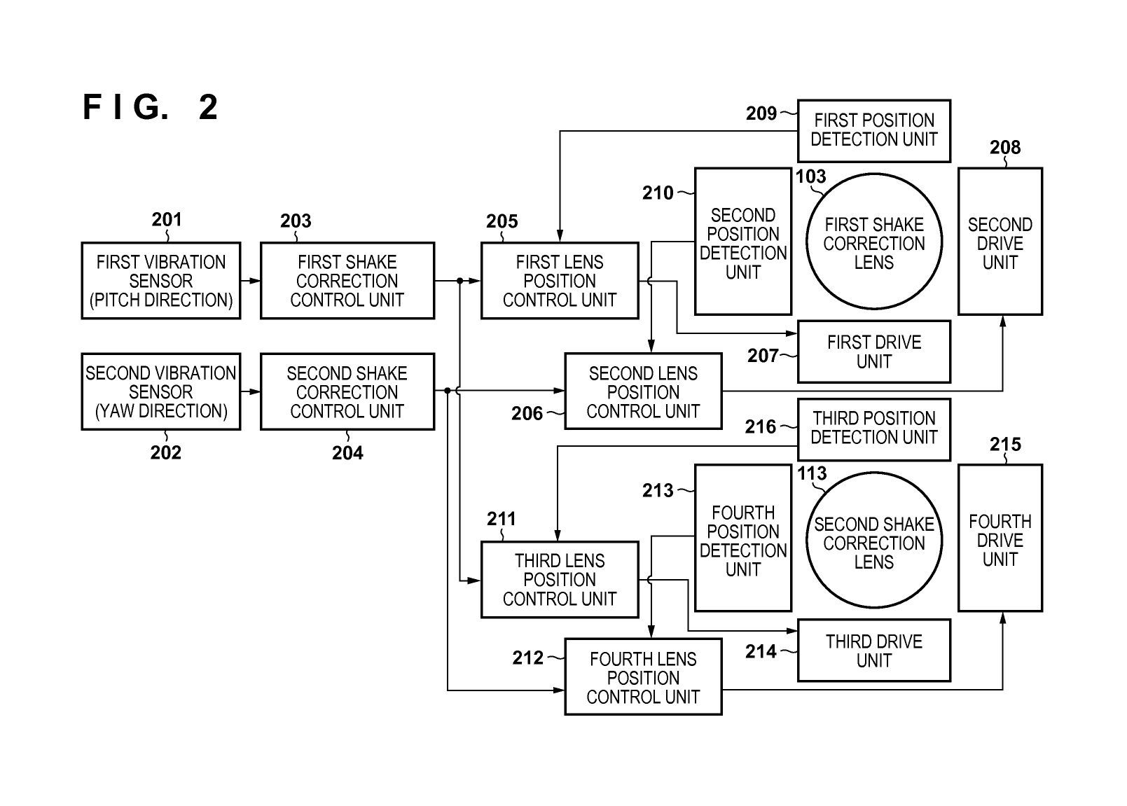

FIG. 2 shows a configuration of the image stabilization apparatus according to the present embodiment. A first vibration sensor 201 is, for example, an angular velocity sensor, and detects vibration of the image capturing apparatus in a vertical direction (pitch direction) during a normal orientation (an orientation in which a lengthwise direction of an image substantially matches a horizontal direction). A second vibration sensor 202 is, for example, an angular velocity sensor, and detects vibration of the image capturing apparatus in the horizontal direction (yaw direction) during the normal orientation. A first shake correction control unit 203 controls driving of the shake correction lenses by outputting correction position control signals for the shake correction lenses in the pitch direction. A second shake correction control unit 204 controls driving of the shake correction lenses by outputting correction position control signals for the shake correction lenses in the yaw direction.

A first lens position control unit 205 performs feedback control based on a correction position control signal in the pitch direction from the first shake correction control unit 203, and on position information of a shake correction lens in the pitch direction from a first position detection unit 209 composed of a Hall element. The first lens position control unit 205 accordingly drives a first drive unit 207, which is, for example, an actuator. Similarly, a second lens position control unit 206 performs feedback control based on a correction position control signal in the yaw direction from the second shake correction control unit 204, and on position information of a shake correction lens in the yaw direction from a second position detection unit 210 composed of a Hall element. The second lens position control unit 206 accordingly drives a second drive unit 208, which is, for example, an actuator.

A description is now given of an operation performed by the first shake correction lens driving unit 104 to drive and control the first shake correction lens 103.

The first vibration sensor 201 supplies the first shake correction control unit 203 with a shake signal (angular velocity signal) indicating a shake of the image capturing apparatus in the pitch direction. The second vibration sensor 202 supplies the second shake correction control unit 204 with a shake signal (angular velocity signal) indicating a shake of the image capturing apparatus in the yaw direction.

The first shake correction control unit 203 generates a correction position control signal for driving the shake correction lens 103 in the pitch direction based on the shake signal supplied thereto, and outputs the correction position control signal to the first lens position control unit 205. The second shake correction control unit 204 generates a correction position control signal for driving the shake correction lens 103 in the yaw direction based on the shake signal supplied thereto, and outputs the correction position control signal to the second lens position control unit 206.

The first position detection unit 209 outputs, as the position information of the first shake correction lens 103 in the pitch direction, a signal having a voltage corresponding to the intensity of a magnetic field attributed to a magnet provided in the first shake correction lens 103. The details of the first position detection unit 209 will be described later. The second position detection unit 210 outputs, as the position information of the first shake correction lens 103 in the yaw direction, a signal having a voltage corresponding to the intensity of the magnetic field attributed to the magnet provided in the first shake correction lens 103. The position information is supplied to the first lens position control unit 205 and the second lens position control unit 206.

The first lens position control unit 205 performs feedback control while driving the first drive unit 207 such that the value of the signal from the first position detection unit 209 converges on the value of the correction position control signal from the first shake correction control unit 203. The second lens position control unit 206 performs feedback control while driving the second drive unit 208 such that the value of the signal from the second position detection unit 210 converges on the value of the correction position control signal from the second shake correction control unit 204.

It should be noted that, due to variations in the values of position signals output from the first position detection unit 209 and the second position detection unit 210, the outputs from the first position detection unit 209 and the second position detection unit 210 are adjusted such that the first shake correction lens 103 moves to a predetermined position in response to a predetermined correction position control signal. This output adjustment will be described later.

Based on shake information from the first vibration sensor 201, the first shake correction control unit 203 outputs the correction position control signal for moving the position of the first shake correction lens 103 so as to cancel out an image blur of the subject image. Based on shake information from the second vibration sensor 202, the second shake correction control unit 204 outputs the correction position control signal for moving the position of the first shake correction lens 103 so as to cancel out the image blur.

For example, the first shake correction control unit 203 and the second shake correction control unit 204 generate correction speed control signals or correction position control signals based on either shake information (angular velocity signals) or shake information that has been, for example, filter-processed. Through the above-described operation, an image blur associated with vibration of up to a certain level can be prevented, even if the image capturing apparatus is subjected to vibration, such as a camera shake, at the time of image capture. The first shake correction control unit 203 and the second shake correction control unit 204 also perform panning control through detection of a panning state of the image capturing apparatus based on the shake information from the first vibration sensor 201 and the second vibration sensor 202, and on the outputs from the first position detection unit 209 and the second position detection unit 210.

An operation performed by the second shake correction lens driving unit 114 to drive and control the second shake correction lens 113 is similar to the operation performed by the first shake correction lens driving unit 104 to drive and control the first shake correction lens 103. That is to say, the first shake correction control unit 203 generates a correction position control signal for driving the second shake correction lens 113 in the pitch direction based on the shake signal supplied thereto, and outputs the correction position control signal to a third lens position control unit 211. The second shake correction control unit 204 generates a correction position control signal for driving the second shake correction lens 113 in the yaw direction based on the shake signal supplied thereto, and outputs the correction position control signal to a fourth lens position control unit 212.

The third lens position control unit 211 performs feedback control while driving a third drive unit 214 such that the value of a signal from a third position detection unit 216 converges on the value of the correction position control signal from the first shake correction control unit 203. The fourth lens position control unit 212 performs feedback control while driving a fourth drive unit 215 such that the value of a signal from a fourth position detection unit 213 converges on the value of the correction position control signal from the second shake correction control unit 204.

In the present embodiment, the first shake correction control unit 203, the first lens position control unit 205, and the first drive unit 207 correct low-frequency components of the shake signal in the pitch direction. The first shake correction control unit 203, the third lens position control unit 211, and the third drive unit 214 correct high-frequency components of the shake signal in the pitch direction.

The second shake correction control unit 204, the second lens position control unit 206, and the second drive unit 208 correct low-frequency components of the shake signal in the yaw direction. The second shake correction control unit 204, the fourth lens position control unit 212, and the fourth drive unit 215 correct high-frequency components of the shake signal in the yaw direction.

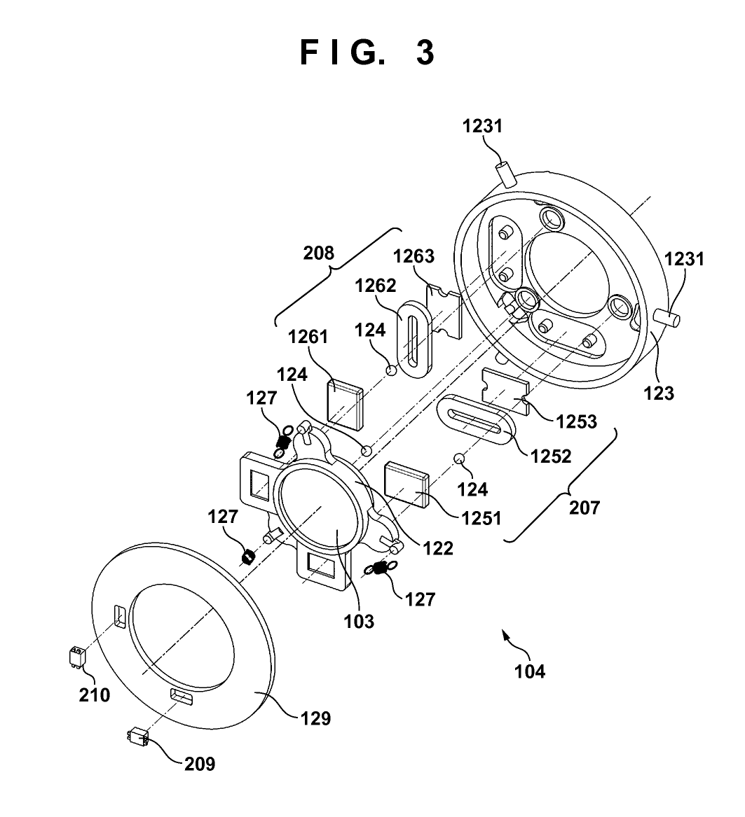

FIG. 3 is an exploded perspective view showing a structure of the first shake correction lens driving unit 104. The first shake correction lens driving unit 104 includes the first shake correction lens 103, a movable lens barrel 122, a fixed ground plate 123, rolling balls 124, a first electromagnetic driving unit 207, and a second electromagnetic driving unit 208. The first shake correction lens driving unit 104 also includes urging springs 127, the first position detection unit 209, the second position detection unit 210, and a detection unit (sensor) holder 129.

The first electromagnetic driving unit 207 includes a first magnet 1251, a first coil 1252, and a first yoke 1253. The second electromagnetic driving unit 208 includes a second magnet 1261, a second coil 1262, and a second yoke 1263.

The first shake correction lens 103 is a first correction optical member capable of decentering the optical axis. The first shake correction lens 103 is driven and controlled by the first shake correction control unit 203 and the second shake correction control unit 204. In this way, an image stabilization operation of moving an optical image that has passed through the imaging optical system is performed, and image stability on an imaging surface can be ensured. Although correction lenses are used as a correction optical system in the present embodiment, image stability on the imaging surface can also be ensured by driving an image sensor, such as a CCD, in a direction perpendicular to the optical axis with respect to the imaging optical system. In other words, the image sensor may be used as a means for correcting an image blur.

The movable lens barrel 122 is a first movable unit that holds the first shake correction lens 103 at a central open portion thereof. The movable lens barrel 122 holds the first magnet 1251 and the second magnet 1261. The movable lens barrel 122 has three rolling ball bearings, and is supported rollably by the rolling balls 124 so as to be movable on a plane perpendicular to the optical axis. The movable lens barrel 122 also has spring hangers at three locations, and is capable of holding one end of each urging spring 127.

The fixed ground plate 123 is a first fixed member that has a shape of a circular hollow cylinder. An outer circumferential portion of the fixed ground plate 123 has followers 1231 at three locations. The movable lens barrel 122 is arranged in a central open portion of the fixed ground plate 123. In this way, the amount of mobility of the movable lens barrel 122 can be restricted.

The fixed ground plate 123 holds the first coil 1252 and the first yoke 1253 at a location opposing a magnetized surface of the first magnet 1251. The fixed ground plate 123 also holds the second coil 1262 and the second yoke 1263 at a location opposing a magnetized surface of the second magnet 1261. The fixed ground plate 123 has three rolling ball bearings, and supports the movable lens barrel 122 via the rolling balls 124 in such a manner that the movable lens barrel 122 is movable on a plane perpendicular to the optical axis. The fixed ground plate 123 also has three spring hangers. With these spring hangers, it holds one end of each urging spring 127.

In the present example, the first electromagnetic driving unit 207 is a known voice coil motor. The Lorentz force is exerted between the first coil 1252 attached to the fixed ground plate 123 and the first magnet 1251 fixed to the movable lens barrel 122 by applying electric current to the former; as a result, the movable lens barrel 122 can be driven. As the second electromagnetic driving unit 208 is a voice coil motor that is similar to the first electromagnetic driving unit 207 but rotated by 90° with respect to the same, a detailed description thereof is omitted.

The urging springs 127 are tension springs that exert an urging force proportional to the amount of deformation. Each urging spring 127 is fixed to the movable lens barrel 122 at one end and to the fixed ground plate 123 at the other end, and exerts an urging force therebetween. The exerted urging force allows the rolling balls 124 to be interposed, that is to say, allows the rolling balls 124 to remain in contact with the fixed ground plate 123 and the movable lens barrel 122.

The first position detection unit 209 and the second position detection unit 210 are two magnetic sensors utilizing the Hall elements that read the magnetic flux of the first magnet 1251 and the second magnet 1261, and a change in the outputs therefrom enables detection of a movement of the movable lens barrel 122 on a plane.

The detection unit holder 129 is substantially disk-shaped and is fixed to the fixed ground plate 123. It can hold the two position detection units 209 and 210 at locations opposing the first magnet 1251 and the second magnet 1261. The detection unit holder 129 can house the movable lens barrel 122 in the internal space formed by itself and the fixed ground plate 123. This prevents falling of internal constituents, even if the image stabilization apparatus is subjected to an impact force or an orientational change. With the above-described configuration, the first shake correction lens driving unit 104 can move the first shake correction lens 103 to any position on a plane perpendicular to the optical axis.

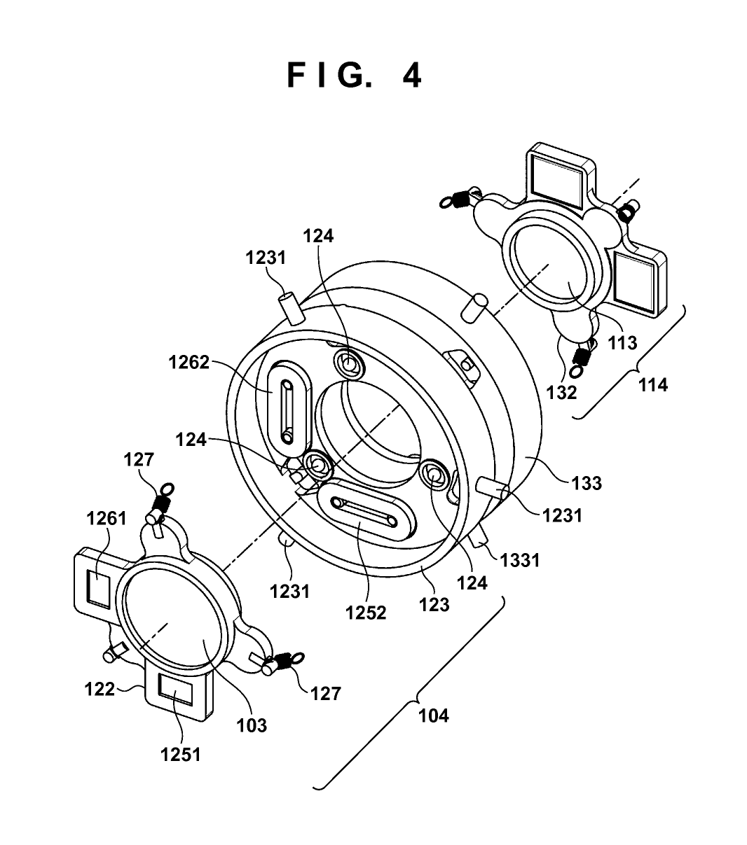

FIG. 4 shows a positional relationship between the first shake correction lens driving unit 104 and the second shake correction lens driving unit 114. In FIG. 4, a part of the shake correction lens driving units is either illustrated in an exploded manner, or omitted, to clarify the explanation. A movable lens barrel 132 is a second movable unit provided in the second shake correction lens driving unit 114. The movable lens barrel 132 holds the second shake correction lens 113 at a central open portion thereof. A fixed ground plate 133 is a second fixed member provided in the second shake correction lens driving unit 114. The second shake correction lens driving unit 114 is configured similarly to the first shake correction lens driving unit, except for the shape of the lens and the shape of the movable lens barrel 132 holding the lens, and hence a detailed description thereof is omitted.

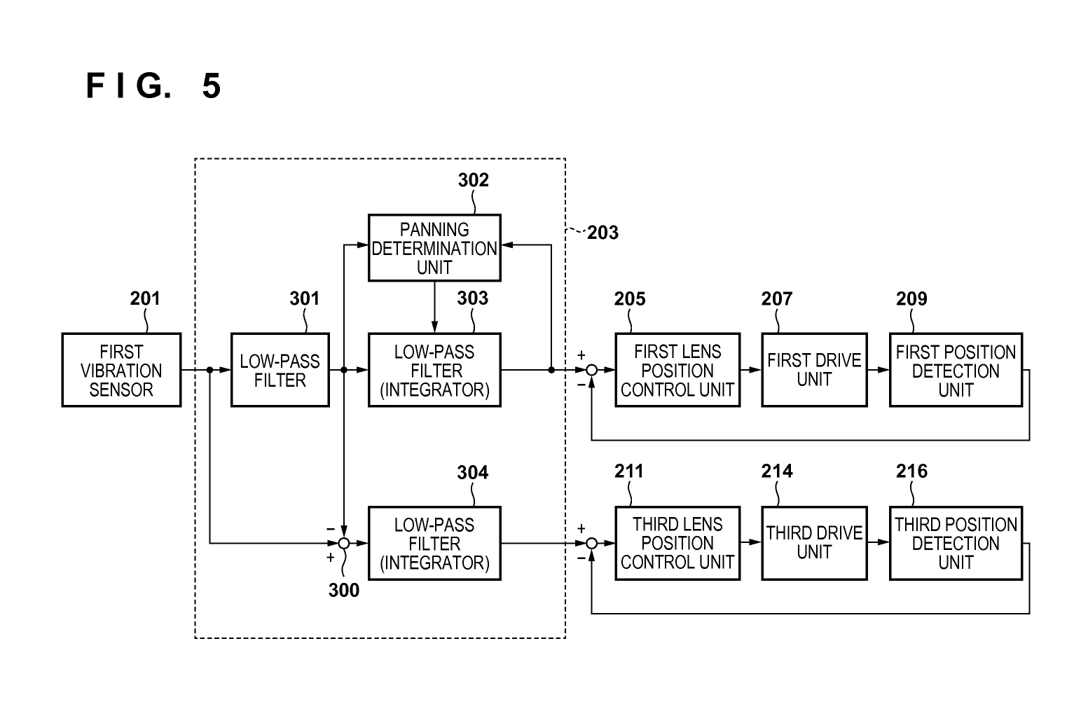

FIG. 5 shows a configuration of the image stabilization apparatus according to the present embodiment for correcting a shake signal in the pitch direction. A mechanism to correct a shake signal in the yaw direction, which is realized by the second shake correction control unit 204, the second lens position control unit 206, the fourth lens position control unit 212, the second drive unit 208, and the fourth drive unit 215, is similar to the configuration shown in FIG. 5, and hence a description thereof is omitted.

In FIG. 5, the first vibration sensor 201 detects a shake information signal (angular velocity signal) indicating a shake to which the image capturing apparatus is subjected. The first shake correction control unit 203 includes low-pass filters (LPFs) 301, 303, and 304, a panning determination unit 302, and a subtractor 300. The LPF 301 extracts low-frequency components from the shake signal detected by the first vibration sensor 201. The LPF 303, a time constant of which is changeable until filter stabilization, applies integration processing to a low-frequency camera shake signal extracted by the LPF 301, thereby generating a shake angle signal including only the extracted low-frequency components. A time constant that is changeable until filter stabilization, for example, means that a cutoff frequency can be changed by changing a filter coefficient, or that a buffer retaining a calculation result during calculation by a filter (an intermediate value) can be freely rewritten at any timing.

The panning determination unit 302 makes a determination about a panning operation of the image capturing apparatus, and executes processing for changing the time constants of the LPF 303 and the LPF 304 until filter stabilization. Specifically, the panning determination unit 302 determines that the panning operation has been performed when the shake signal detected by the first vibration sensor 201 has a prescribed value or more. The panning determination unit 302 may determine that the panning operation has been performed when a current position of the first shake correction lens 103 and a current position of the second shake correction lens 113 have a prescribed value or more. The panning determination unit 302 may determine that the panning operation has been performed when a target position of the first shake correction lens 103 and a target position of the second shake correction lens 113 have a prescribed value or more. In this way, when the image capturing apparatus is subjected to a large shake, the first shake correction lens 103 and the second shake correction lens 113 can be prevented from being driven beyond a movable range, and a captured image can be prevented from being unstable due to a reverse shake that immediately follows a panning operation.

The subtractor 300 extracts high-frequency components from the camera shake signal detected by the first vibration sensor 201 by subtracting the low-frequency components extracted by the LPF 301 from the camera shake signal. The LPF 304 converts angular velocity information into angle information by applying integration processing to the extracted high-frequency components, thereby generating a camera shake angle signal including only the extracted high-frequency components. It should be noted that the LPF 303 and the LPF 304 can produce outputs of any magnification by changing the coefficients thereof.

A shake correction lens target position is generated from the low-frequency components of the camera shake angle signal generated in the above-described manner, and then input to the first lens position control unit 205. Similarly, a shake correction lens target position is generated from the high-frequency components of the camera shake angle signal, and then input to the third lens position control unit 211.

The position information of the first shake correction lens 103 detected by the first position detection unit 209 is compared with the lens target position output from the low-pass filter 303. Subsequently, a shake correction operation is performed through positional feedback control via the first drive unit 207.

The position information of the second shake correction lens 113 detected by the third position detection unit 216 is compared with the lens target position output from the low-pass filter 304. Subsequently, a shake correction operation is performed through positional feedback control via the third drive unit 214. Any control calculator may be used as the first lens position control unit 205 and the third lens position control unit 211. In the present example, a PID controller is used as the first lens position control unit 205 and the third lens position control unit 211.

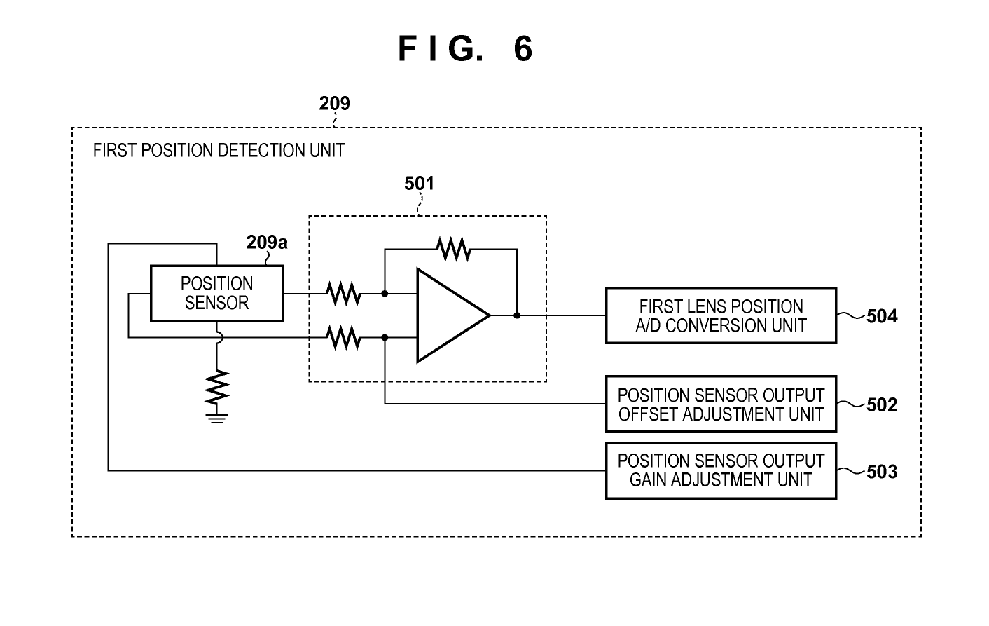

A description is now given of position detection by the first position detection unit 209 with reference to FIG. 6. As stated earlier, a position sensor 209a of the first position detection unit 209 and a position sensor of the second position detection unit 210 are two magnetic sensors utilizing the Hall elements that read the magnetic flux of the first magnet 1251 and the second magnet 1261, and a change in the outputs therefrom enables detection of a movement of the movable lens barrel 122 on a plane.

Processing for the output from the position sensor 209a will now be described. A voltage signal output from the position sensor 209a is amplified by an amplifier unit 501. An operational amplifier is used as this amplifier unit 501. A first lens position A/D conversion unit applies A/D conversion to the voltage signal amplified by the amplifier unit 501. The first lens position control unit 205 performs positional feedback control using the position information yielded from the A/D conversion.

Adjustment of the output from the position sensor 209a will now be described. A position sensor output offset adjustment unit 502 applies voltage to the amplifier unit for the output from the Hall element; in this way, a voltage offset is added to the amplified Hall output, and the position of the shake correction lens can be adjusted. A position sensor output gain adjustment unit 503 controls the output from the Hall element by applying a predetermined voltage to the input side of the Hall element.

While position detection by the first position detection unit 209 and adjustment of the output from the Hall element have been described above, the second, third, and fourth position detection units 210, 216, and 213 are configured similarly to the configuration shown in FIG. 6, and hence a detailed description thereof is omitted.

A description is now given of a method used by the position sensor output offset adjustment unit 502 to decide on a driving center position of the shake correction lens, and a method used by the position sensor output gain adjustment unit 503 to set the amount of driving of the shake correction lens such that the amount of change in an angle of view corresponds to a predetermined shake correction instruction.

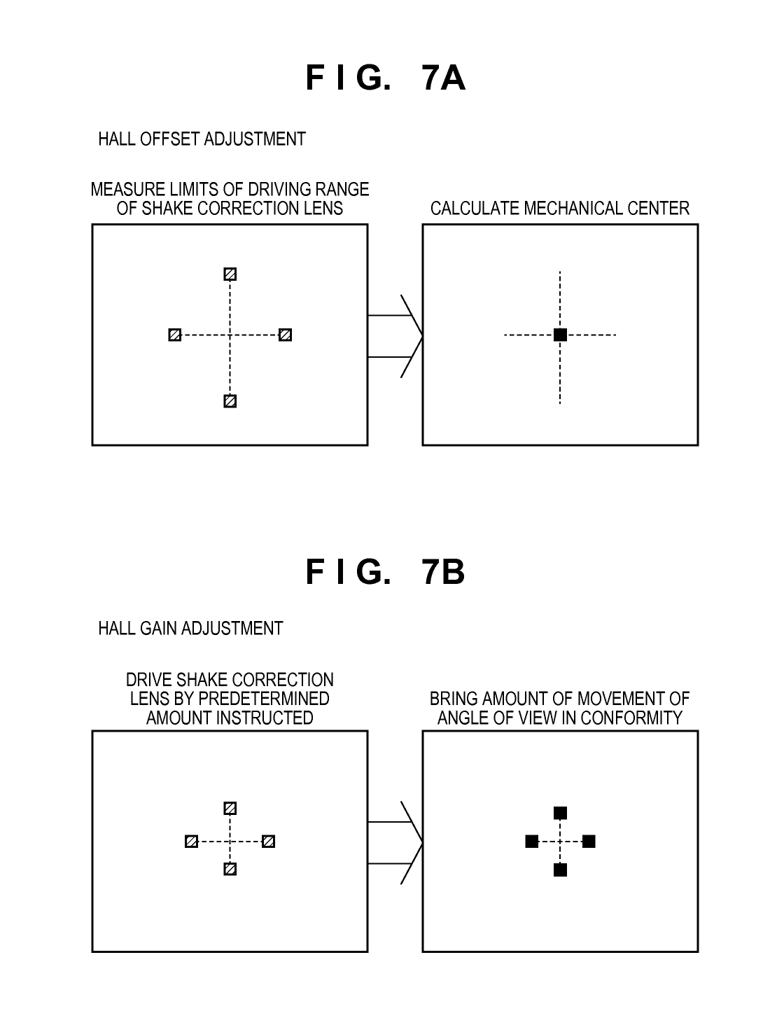

FIGS. 7A and 7B show a method of adjusting the output from the Hall element according to the present embodiment. A mechanical center of a movement of the shake correction lens is calculated using the position sensor output offset adjustment unit 502 as follows. First, the shake correction lens is driven by notifying the position sensor output offset adjustment unit 502 of a moving instruction for driving the shake correction lens to the limits of a mechanical driving range in the horizontal and vertical directions. A midpoint of such limits of the driving range serves as a mechanical center (acquisition of this mechanical center by the position sensor output offset adjustment unit 502 is referred to as Hall offset adjustment). A center position of the shake correction lens obtained as a result of this procedure is referred to as a mechanical center, and serves as a driving center position at the time of shake correction (see FIG. 7A). In the case of a mechanical design in which this mechanical center also serves as an optical axis center, the driving center serves as the optical axis center. In the present embodiment, the mechanical center is equal to the optical axis center.

The amount of driving of the shake correction lens is set using the position sensor output gain adjustment unit 503 as follows (see FIG. 7B). First, the shake correction lens is driven by notifying the first lens position control unit 205 of a moving instruction for driving the shake correction lens by a predetermined amount in the horizontal and vertical directions on a plane of the mechanical driving range. A value of the position sensor output gain adjustment unit 503 is set such that the amount of change in the angle of view at this time is equal to a predetermined amount (e.g., 0.1 degrees). A value obtained as a result of this procedure is referred to as a Hall gain value, and adjustment thereof is referred to as Hall gain adjustment. Through this Hall gain adjustment, the amount of driving of the shake correction lens corresponding to the amount of movement of the angle of view by 0.1 degrees is decided on. Hall offset adjustment and Hall gain adjustment are collectively referred to as Hall adjustment herein. In addition, Hall adjustment is performed at the position of a telephoto end herein.

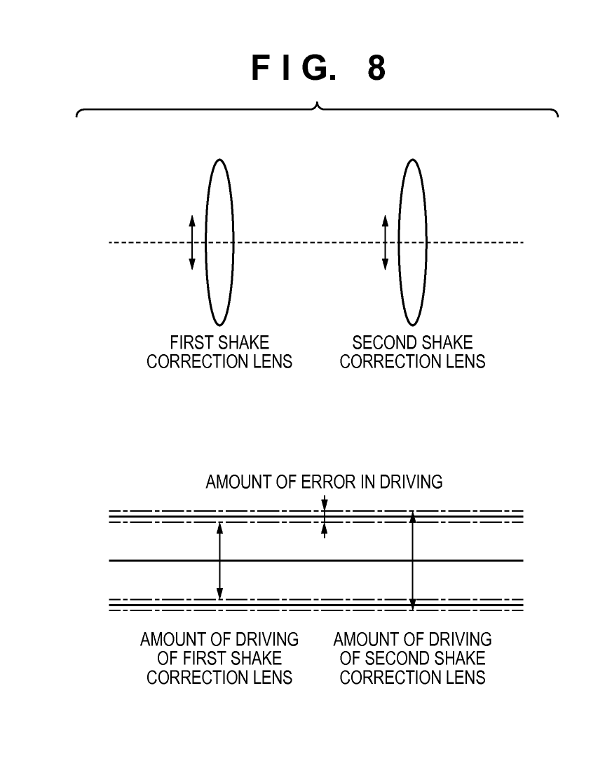

FIG. 8 depicts a case in which hall adjustment is applied separately to each of the first and second shake correction lenses. Although minute, error is included in the result of adjusting the first and second shake correction lenses such that the angle of view changes by a predetermined amount in response to a predetermined instruction value. In a case where the first and second shake correction lenses are assigned their respective amounts of correction by separating the output from the angular velocity sensor into a low-frequency bandwidth and a high-frequency bandwidth as expounded with reference to FIG. 5, mismatch between the amount of driving of the first shake correction lens and the amount of driving of the second shake correction lens gives rise to a remaining blur.

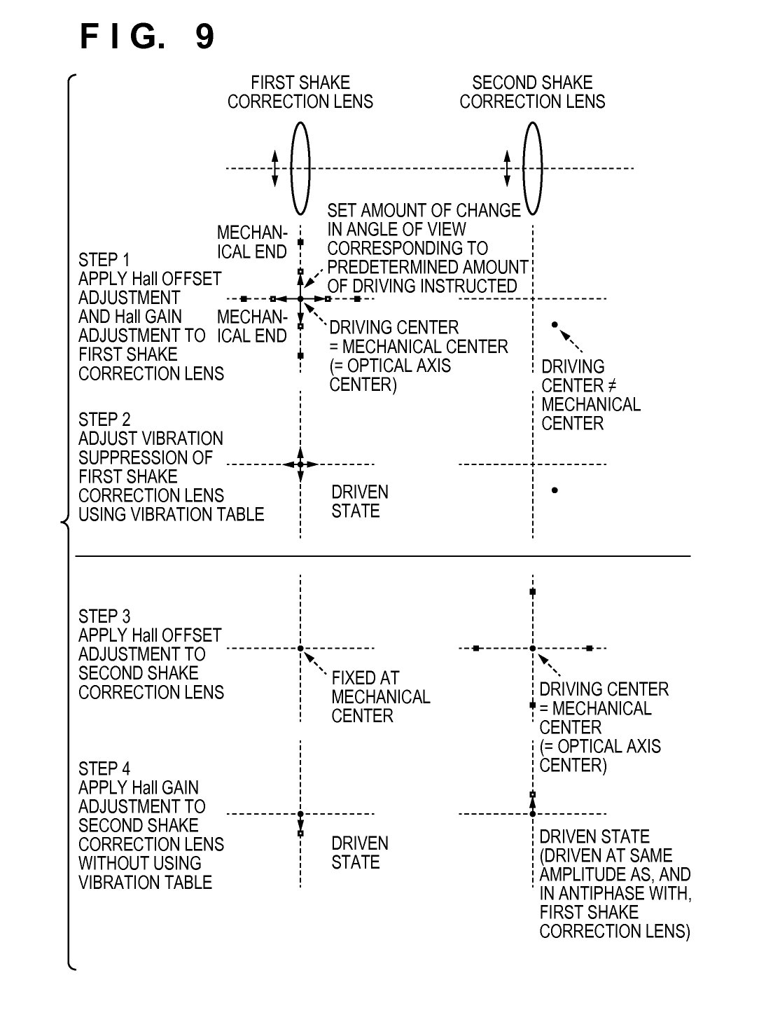

In a case where Hall adjustment is applied separately in the above-described manner, the effects of correction are reduced with the occurrence of adjustment error. In view of this, the present embodiment prevents the reduction in the effects of correction caused by misadjustment by bringing the amount of driving of the second shake correction lens into conformity with the amount of driving of the first shake correction lens. This is depicted in FIG. 9.

FIG. 9 illustrates a method of adjusting the first and second shake correction lenses according to the present embodiment. In step 1, Hall adjustment is applied to the first shake correction lens. The details are similar to FIG. 7, that is to say, Hall offset adjustment is performed such that a driving center coincides with a mechanical center (=an optical axis center), and Hall gain adjustment is performed such that the angle of view changes by a desired value in response to a predetermined amount of driving instructed. As Hall adjustment is not applied to the second shake correction lens, a driving center and a mechanical center differ from each other (the driving center the mechanical center) in the second shake correction lens.

In step 2, vibration suppression adjustment is applied to the first shake correction lens using a vibration table. The vibration table is shaken by applying thereto vibration of a predetermined frequency and amplitude (e.g., 2 Hz, ±0.1 degrees), and the amount of vibration suppression gain that would stop an image shake is set. In the present embodiment, the amount of vibration suppression gain is set by changing the coefficients of the LPF 303 and the LPF 304.

The present embodiment uses a shake correction control method in which the output from the angular velocity sensor is separated into a low-frequency band and a high-frequency band, and the first and second shake correction lenses are assigned the low-frequency band and the high-frequency band, respectively. However, the adjustment steps can be carried out using a predetermined output signal for each of the first and second shake correction lenses without assigning separate frequency bands; in the present embodiment, driving is performed using a predetermined instruction value.

Subsequently, in step 3, Hall offset adjustment is applied to the second shake correction lens. A Hall offset value is set such that a driving center coincides with a mechanical center in the second shake correction lens in a similar manner. At this time, the first shake correction lens is fixed at the driving center thereof.

Then, Hall gain adjustment is applied to the second shake correction lens to match with the amount of driving of the first shake correction lens, unlike conventional setting methods. This is depicted as step 4. First, the first shake correction lens is driven by a predetermined instruction value (e.g., by an amount of driving corresponding to 0.1 degrees, in an upward direction), and then the second shake correction lens is driven, in antiphase, by the same instruction value (in this case, in a downward direction with a phase shift of 180 degrees). At this time, a Hall gain value is set so as to maintain the original angle of view (such that a difference from the original angle of view is a local minimum). More precise matching can be achieved by setting a Hall gain adjustment value for the second shake correction lens to have a higher resolution than that for the first shake correction lens.

As described above, the second shake correction lens is driven by the same instruction value as, and in antiphase with, the first shake correction lens; as long as the angle of view does not change, the first and second shake correction lenses have the same amplitude characteristics. This prevents the reduction in the effects of correction caused by adjustment error. Although a gain of the second shake correction lens is corrected in the above-described present embodiment, gain correction may be performed using the first shake correction lens.

Although a correction gain of the second shake correction lens is brought into conformity through Hall gain adjustment in the first embodiment, this can be implemented also by applying a correction gain to the amount of shake correction (the amount of driving instructed) obtained from the output from the angular velocity sensor.

### Second Embodiment

A second embodiment will now be described. In the second embodiment described below, a driving amplitude of the second shake correction lens is brought into conformity with that of the first shake correction lens using the amount of shake correction (the amount of driving instructed). In the present embodiment, constituents that are configured in the same manner as their counterparts in the first embodiment are given the same reference numerals, and a description thereof is omitted.

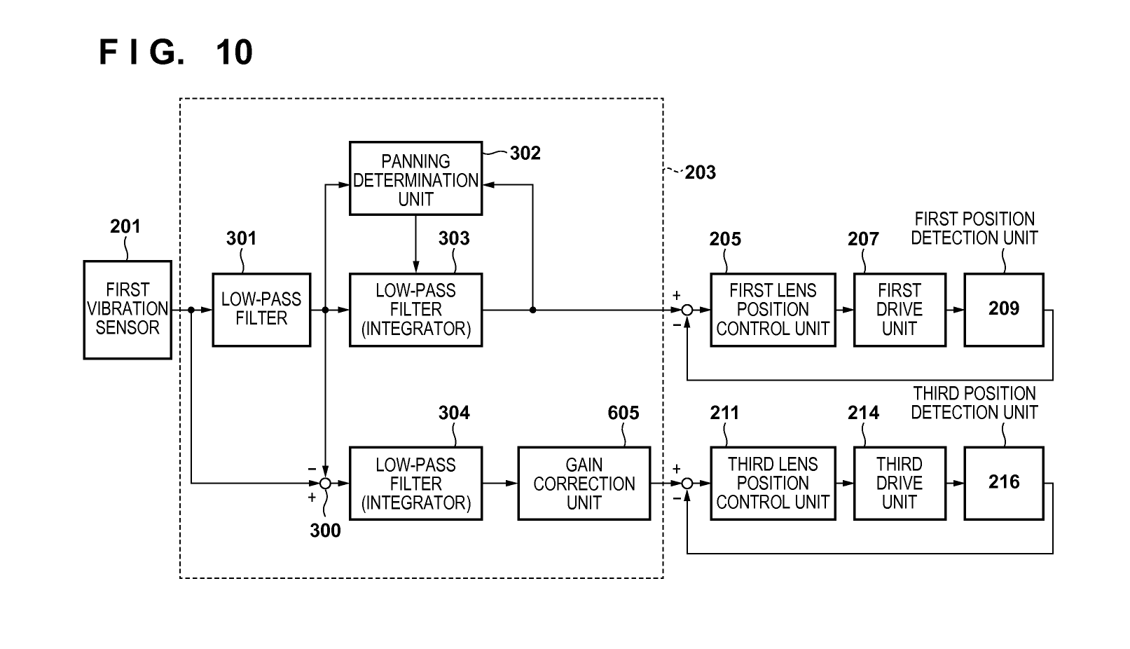

FIG. 10 shows a block diagram related to shake correction according to the second embodiment. Although driving of the first shake correction lens is similar to the first embodiment, control of the second shake correction lens differs from the first embodiment.

The LPF 301 extracts low-frequency components from the shake signal detected by the first vibration sensor 201. The subtractor 300 extracts high-frequency components from the camera shake signal detected by the first vibration sensor 201 by subtracting the low-frequency components extracted by the LPF 301 from the camera shake signal. The LPF 304 converts angular velocity information into angle information by applying integration processing to the extracted high-frequency components, thereby generating a camera shake angle signal including only the extracted high-frequency components. A gain correction unit 605 applies signal output adjustment to an output signal yielded from integration by the LPF 304, that is to say, amplifies or reduces the output signal. Although a gain of the second shake correction lens is corrected in the above-described present embodiment, gain correction may be performed using the first shake correction lens.

A Hall adjustment method utilizing this gain correction unit is implemented as follows. In step 1 to step 3 of FIG. 9, similar adjustment is applied, whereas in step 4, a fixed value (e.g., an average value of multiple samples) is used as a Hall adjustment value for the second shake correction lens. When the second shake correction lens is driven in antiphase based on the amount of driving instructed for the first shake correction lens, a driving gain corresponding to the amount of driving instructed is set using the gain correction unit 605 so as not to cause a change in the angle of view. In the case of a correction method utilizing this gain correction unit, conformity is achieved through computation by firmware, and hence fine settings can be configured.

### Third Embodiment

The first and second embodiments only bring the amplitude of the second shake correction lens into conformity; however, in a case where driving of the first shake correction lens and driving of the second shake correction lens have different frequency response characteristics, a remaining blur occurs in image stabilization due to a shift between driving phases (image stabilization phases) despite the same amplitude. A third embodiment described below introduces a method of not only bringing a driving amplitude of the second shake correction lens into conformity with a driving amplitude of the first shake correction lens using the amount of shake correction (the amount of driving instructed), but also bringing the first and second shake correction lenses in phase. In the present embodiment, constituents that are configured in the same manner as their counterparts in the first and second embodiments are given the same reference numerals, and a description thereof is omitted.

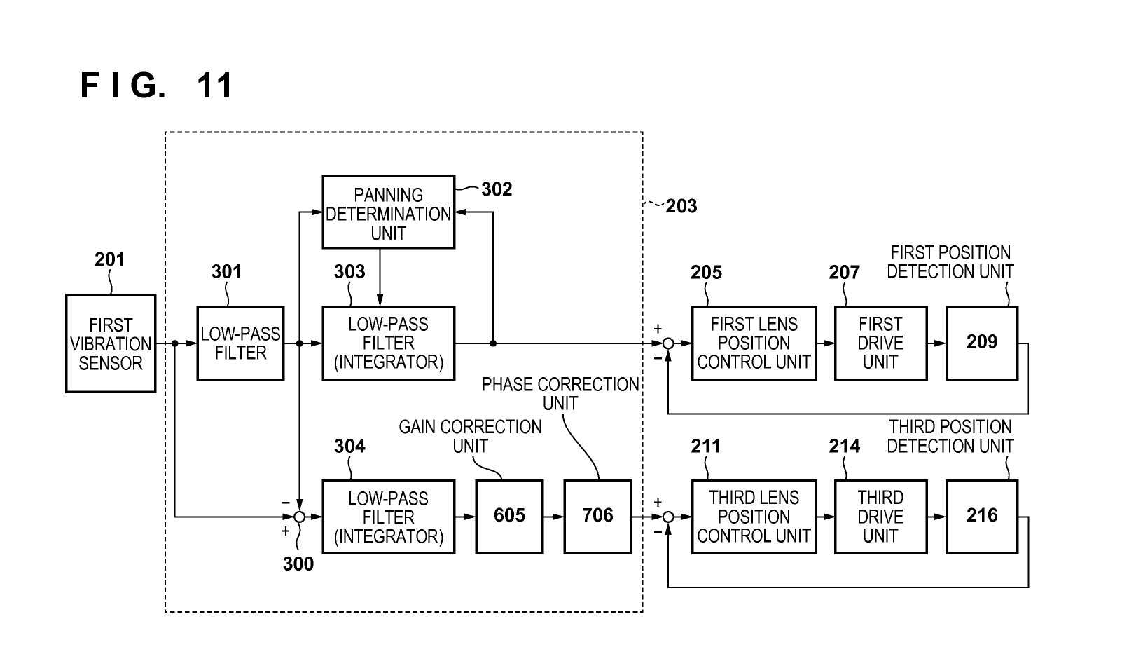

FIG. 11 shows a block diagram related to shake correction according to the third embodiment. Although driving of the first shake correction lens is similar to the first embodiment, control of the second shake correction lens differs from the first embodiment.

The LPF 301 extracts low-frequency components from the shake signal detected by the first vibration sensor 201. The subtractor 300 extracts high-frequency components from the camera shake signal detected by the first vibration sensor 201 by subtracting the low-frequency components extracted by the LPF 301 from the camera shake signal. The LPF 304 converts angular velocity information into angle information by applying integration processing to the extracted high-frequency components, thereby generating a camera shake angle signal including only the extracted high-frequency components. The gain correction unit 605 applies signal output adjustment to the output signal yielded from integration by the LPF 304, that is to say, amplifies or reduces the output signal.

A phase correction unit 706 is used to change the phase of the output from the gain correction unit 605. For example, a phase lead filter (PLF) or a phase delay filter (PDF) may be used thereas.

In a case where the shake correction lenses have different frequency response characteristics, equalizing only their amplitudes gives rise to a remaining blur; in view of this, the phase correction unit 706 brings the shake correction lenses in phase so as to eliminate the remaining blur and allow for optimal shake correction using both of the first and second shake correction lenses. Although the gain and phase of the second shake correction lens are corrected in the above-described present embodiment, gain and phase correction may be performed using the first shake correction lens.

A Hall adjustment method utilizing this gain correction unit is implemented as follows. In step 1 to step 3 of FIG. 9, similar adjustment is applied, whereas in step 4, a fixed value (e.g., an average value of multiple samples) is used as a Hall adjustment value for the second shake correction lens. When the second shake correction lens is continuously driven in antiphase based on the amount of driving instructed for the first shake correction lens, a driving gain and phase corresponding to the amount of driving instructed are set using the gain correction unit 605 and the phase correction unit 706 so as not to cause a change in the angle of view. It is sufficient to perform continuous driving using, for example, a sine wave (e.g., a sine wave of 3 Hz, ±0.1 degrees).

The present description has provided an example in which conformity is achieved with respect to a driving frequency of 3 Hz; however, gain and phase correction information may be prestored in correspondence with several frequencies, e.g., a frequency of approximately 1 Hz that is likely to occur with a body shake, a frequency of approximately 2 Hz associated with image capture while walking, and a frequency of approximately 5 Hz or 10 Hz associated with image capture while holding a camera with one hand, and a control sequence may automatically select gain and phase correction information in accordance with a scene being captured by the camera and the shake characteristics at the time of image capture.

Although the above-described embodiments have introduced a method of adjusting the driving characteristics of the first and second shake correction lenses, automatic correction may be performed at a predetermined timing during standby for image capture in a normal camera operation. Specifically, if the output from an angular velocity sensor remains at a predetermined threshold or smaller for a predetermined time period (e.g., 3 seconds) when shakes are small, such as when the camera is mounted on a desk or a tripod, the first and second shake correction lenses are continuously driven in antiphase, and gain correction and phase correction are automatically performed so as not to cause a change in the angle of view. For example, more preferable shake correction effects are expected when correction is performed upon a change in the driving characteristics of the shake correction lenses caused by a change in an image capture environment, such as a change to a high ambient temperature, a low ambient temperature, and a high-humidity condition. Alternatively, automatic correction may be added as an item of menu settings so that it can be performed whenever a user likes.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-181600, filed Sep. 5, 2014 which is hereby incorporated by reference herein in its entirety.

What is claimed is:

1. An image processing apparatus, comprising:
a setting unit that sets an image stabilization gain of a first image stabilization unit and an image stabilization gain of a second image stabilization unit, the first and second image stabilization units correcting an image blur of a subject image generated by a shake of the apparatus, wherein
when the first and second image stabilization units are driven such that the first and second image stabilization units are a different phase with each other by 180 degrees, the setting unit sets the image stabilization gain of the second image stabilization unit such that an amount of a remaining blur in an image is a local minimum.

2. The image processing apparatus according to claim 1, wherein
at least one of the first and second image stabilization units is an image stabilization lens that is provided in an imaging optical system and that moves in a direction perpendicular to an optical axis of the imaging optical system.

3. The image processing apparatus according to claim 1, wherein
at least one of the first and second image stabilization units is a driving unit that moves an image sensor in a direction perpendicular to an optical axis, the image sensor capturing the subject image.

4. The image processing apparatus according to claim 1, further comprising:
a position detection unit that detects a position of the first image stabilization unit and a position of the second image stabilization unit; and
an amplifier unit that amplifies an output from the position detection unit, wherein
the amplifier unit sets the image stabilization gains.

5. The image processing apparatus according to claim 1, further comprising:
a shake detection unit that detects the shake of the apparatus;
a calculation unit that calculates an amount of correction from an output from the shake detection unit; and
a gain unit that amplifies the amount of correction calculated by the calculation unit, wherein
the gain unit sets the image stabilization gains.

6. The image processing apparatus according to claim 1, further comprising:
an adjustment unit that adjusts an image stabilization phase of the first image stabilization unit and an image stabilization phase of the second image stabilization unit, wherein
the first and second image stabilization units are continuously driven such that the first and second image stabilization units are a different phase with each other by 180 degrees, the image stabilization gain of the second image stabilization unit is set such that the amount of the remaining blur in the image is the local minimum, and the image stabilization phase of the second image stabilization unit is adjusted.

7. The image processing apparatus according to claim 5, further comprising:
a control unit that, when the output from the shake detection unit remains smaller than a predetermined value for a predetermined time period while the apparatus is on standby for image capture, continuously drives the first and second image stabilization units such that the first and second image stabilization units are a different phase with each other by 180 degrees, and automatically sets the image stabilization gain of the second image stabilization unit and an image stabilization phase of the second image stabilization unit such that the amount of the remaining blur in the image is the local minimum.

8. A method for controlling an image processing apparatus that drives a first image stabilization unit and a second image stabilization unit for correcting an image blur of a subject image generated by a shake of the apparatus, the method comprising:
setting an image stabilization gain of the first image stabilization unit and an image stabilization gain of the second image stabilization unit, wherein
when the first and second image stabilization units are driven such that the first and second image stabilization units are a different phase with each other by 180 degrees, the setting sets the image stabilization gain of the second image stabilization unit such that an amount of a remaining blur in an image is a local minimum.

9. A computer-readable storage medium storing a program for causing a computer to execute a method for controlling an image processing apparatus that drives a first image stabilization unit and a second image stabilization unit for correcting an image blur of a subject image generated by a shake of the apparatus, the method comprising:
setting an image stabilization gain of the first image stabilization unit and an image stabilization gain of the second image stabilization unit, wherein
when the first and second image stabilization units are driven such that the first and second image stabilization units are a different phase with each other by 180 degrees, the setting sets the image stabilization gain of the second image stabilization unit such that an amount of a remaining blur in an image is a local minimum.
